(19) United States
(12) Patent Application Publication
(10) Pub. No.: US 2006/0099562 A1
(43) Pub. Date: May 11, 2006

(54) Learning system and method

(76) Inventor: Niss Jonas Carlsson, Solna (SE)

Correspondence Address: LACKENBACH SIEGEL, LLP, LACKENBACH SIEGEL BUILDING, 1 CHASE ROAD, SCARSDALE, NY, 10583, US

(21) Appl. No.: 10/520,893

(22) PCT Filed: Jun. 30, 2003
(86) PCT No.: PCT/SE03/01147

§ 371 Date: Aug. 29, 2005

Related U.S. Application Data
(60) Provisional application No. 60/404,122, filed on Aug. 19, 2002.

(30) Foreign Application Priority Data
Jul. 9, 2002 (SE) 0202168-1

(51) Int. Cl. G09B 3/00

(52) U.S. Cl. 434/350

(57) ABSTRACT

System, method and computer program product providing a learning tool, whereby a user can learn any subject in a selective way, whereby the learning tool is implemented in a computer program, which tool is typically available by means of a communication network such as the Internet.

### FIELD OF THE INVENTION

The present invention relates to a learning system and method for individual training. In particular, the invention relates to such a system and method that provide a user access at any desired time point or location.

### BACKGROUND ART

Today there is a great demand in learning; however, unfortunately most of what we learn is forgotten after a short period of time. The phenomenon of forgetting depends on several parameters such as the nature of the subject, the occurrence of interferences of similar material, and of course other factors. However, typically, it takes a smaller effort to recall what is learned with every new session taking place. This is typically used by several learning methods, for instance by using so-called “flashcards” as a learning tool. A flashcard typically comprises a question and an answer printed on a cardboard. An example of an improved way of using flashcards was researched by the German psychologist Sebastian Leitner in the early 1970s. He described a so-called “learning machine” consisting of five or more consecutive compartments, whereby a flashcard in one compartment is transferred to the next compartment if a question is correctly answered by a user, or transferred to the first compartment in case of a wrong answer. In this way, at any time, the number of flashcards present in each compartment gives a feedback of the present state of the user's knowledge allowing the user to set priorities without major planning efforts. This method finds application in a number of areas such as language interpreters etc. However, a drawback is that this method is not dynamic, i. e. it is based on activity, i. e. a user has to use this method without interruption in time, otherwise problems will arise. Typically, the user cannot go back at a later point in time in an easy way. i. e. user knowledge cannot be predicted.

Today similar learning machines can be provided by means of computer programs functioning as effective and flexible learning tools, for instance for learning vocabulary. In this way also monitoring and staticical information for instance about progress in learning can also be provided.

At present, in particular with the development of the Internet, teaching at distance has become very popular since students can learn without being present in a class-room. An example of how the Internet is employed for teaching is described in U.S. Pat. No. 5,909,589, in which an apparatus and method for verifying a user in a network based application is described. The user has to define himself in the system by entering user-specific data such as name and telephone number, which data is stored in a data base. A lot of documents in the field of web based education, which will not be further described, concern problems of supervising education or other problems such as data base structure etc.

Another example of a learning technique is described on the Internet site wwwr.paul-raedle.de describing a vocabulary learning software called “VTrain”. This software operates in the same way as the described flashcards.

Often, there is also a problem with searching data that is relevant for a particular user, since individuals are often very different, and there are problems in organising an individual training program. These problems and further problems are discussed for instance in Swedish patent application 0002315-0.

### SUMMARY OF THE INVENTION

An objective of the invention is to provide a system and method providing dynamic automatised user specific learning. Herein, the term “automatised” refers to a machine or tool that improves a learning process.

An aspect of the present invention is to provide a system and method for learning, which provide user specific teaching, whereby the system and the method estimate and/or predicts a user's knowledge in each point in time. This is not described by any of the prior art documents.

Yet another aspect of the invention is to employ knowledge, both preacquired and learned for teaching and learning purposes. Herein, the term “preacquired” is referred to as knowledge a user had acquired before training, and the term “learned” is referred to knowledge acquired while using the invention.

The system according to the first aspect of the invention can be realised in a system for individual learning, according to a preferred embodiment of the invention, said system comprising:
an apparatus for controlling the learning system,
at least one communication network,
at least one user terminal,
at least one first data base provided with questions and answers, said first data base being connectable to said apparatus, wherein said apparatus further comprises at least a second data base for storing user specific data, means for identification and/or verification of a user, administration means providing said user to control the system, and means for registration of transactions a user performs, wherein said apparatus

is connectable to a learning tool comprising an interface for presenting data to the user, wherein the learning tool is arranged to provide selective learning/training according to the user's knowledge level which is estimated and/or predicted by the system.

Herein, the tern “level” also refers to all knowledge below that level.

According to yet another aspect of the invention, data is presented in the form of information units, typically as question/answer (Q/A) unais.

Another aspect of the invention is to provide a sorting tool for optimised repetition of questions for short term retention. Herein, “short term” is a period of time approximately within one day.

Yet another aspect of the invention is to provide a filter tool for presenting questions/answers in a particular order to a user.

Yet another aspect of the invention is to provide a tool for learning according to a target and measuring learning speed.

Preferably, the sorting tool, the filter tool and the tool for learning according to a target are provided in the learning tool.

Yet another aspect of the invention is to provide a testing tool for optimised repetition of questions for long term retention. Herein, “long term” is a period of time longer than one day.

Yet another aspect of the invention is to provide a data base tool for storing user specific data or data corresponding to groups of users, whereby a user group manager could be a teacher.

Yet another aspect of the invention is to provide a diagnosis tool.

Yet another aspect of the invention is to provide an extraction tool.

Yet another aspect of the invention is to provide an intelligent proactive dictionary.

Yet another aspect of the invention is to provide a tool for extracting individually adapted teaching and learning material. This tool is preferably adapted to be employed by a teacher, not a user.

According to yet another embodiment of the invention, there is provided a method for individual learning in a learning system, comprising an apparatus for controlling the learning system,
at least one communication network
at least one user terminal,
at least one content data base provided with questions and answers, at least a system data base for storing user specific data, a learning tool for presenting data to the user are provided, said method comprising the steps of:
showing at least one question for the user,
presenting a corresponding answer to said at least one question,
urging the user to self-assess if the user's answer was correct or not to said at least one question,
estimating and/or predicting the user's knowledge.

According to yet another embodiment of the invention, there is provided a method for individual learning in a learning system, comprising an apparatus for controlling the learning system,
at least one communication network,
at least one user terminal,
at least one content data base provided with questions and answers, at least a system data base for storing user specific data, a learning tool for presenting data to the user are provided, said method comprising the steps of:
showing at least one question for the user,
receiving an input from the user to said at least one question,
determining if correct answer or not, characterised in
estimating and/or predicting the user's knowledge.

According to yet another embodiment of the invention, there is provided a computer program product for a computer.

There are many advantages with the present invention, of which one is that the leaning system estimates and predicts a user's knowledge. Other advantages are selective learning, stress-free training, immediate feed-back and combined learning/testing. Another typical advantage is a dictionary that can present translations to, for the user, in the text unknown words simultaneuosly while reading said digital text.

Today most users need to get up from the computer, walk to the bookcase and then check an unknown word in the dictionary. In best case the user uses a software dictionary that will give a translation, but still requires some kind of action by the user.

Another advantage is the integration of the dictionary to the learning tool. To the user unknown words found while reading a media, e.g. the Internet, are automatically transferred for training.

### BRIEF DESCRIPTION OF DRAWINGS

The present invention will also be more clearly understood from the following description of the preferred embodiments of the invention read in conjunction with the attached drawings, in which:

FIG. 1 illustrates an overall block diagram of system according to a preferred embodiment of the invention.

FIG. 2 illustrates an apparatus for controlling a learning system according to a preferred embodiment of the invention.

FIG. 3 illustrates a learning tool according to a preferred embodiment of the invention.

FIG. 4 illustrates a preferred embodiment of the apparatus according to the invention, wherein a proactive dictionary is implemented.

FIG. 5 illustrates a flow chart of a preferred embodiment of the method according to the invention.

### DETAILED DESCRIPTION OF THE INVENTION

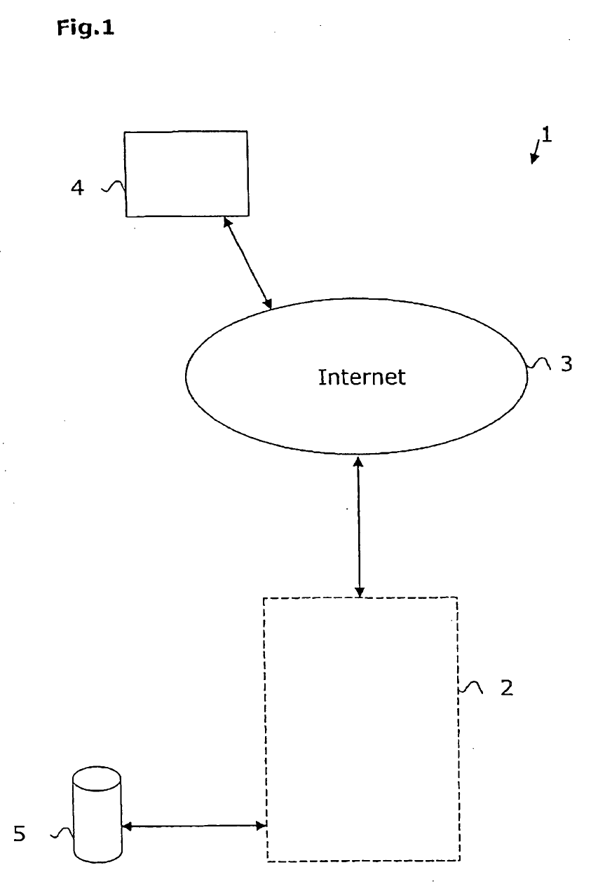

Now is referred to FIG. 1 illustrating a block diagram of a learning system 1 according to a preferred embodiment of the invention. The system 1 comprises an apparatus 2 for controlling the learning system 1, which apparatus 2 will be further described below. The apparatus 2 for controlling the learning system is connected to (or distributed in) a communication network 3, in this case the Internet, typically by means of a web-server (not shown because of simplicity). However, also other networks such as intranets etc are possible without departing from the inventive idea. A fire-wall or the like between the web-server and the communication network can also be provided, but is not shown because of simplicity. Also the number of networks can be any suitable number, such as two or more, whereby transmission route can be selected depending on requirements, which are typically user specific. Thus, the term “communication network includes one or more networks of any suitable type. As illustrated in FIG. 1, user terminals 4 (of which only one is shown because of simplicity), which can be mobile are connected or connectable (illustrated by a doubleheaded arrow) to the communication network 3. Examples of user terminals include mobile phones, cordless phones, personal digital assistants (PDAs), conventional PCs, laptops, digital scanning pens, hand scanning apparatus etc, or can be any type of terminal interface such as a webbrowser or the like, which can communicate via the communication network 3 directly, or indirectly using any type of adaptation device.

To the apparatus 2 a content data base 5 is connected (or connectable). The content data base 5 can comprise data about one or more subjects, which data can be used for learning etc. Herein, the term “content data base” is referred to any data base that is connectable to the apparatus 2, from which data base content can be provided. The apparatus 2, which can be realised as an application layer by means of a software-only solution (illustrated by a dashed line) comprises a number of means to be able to extract data from the content data base 5, providing services (such as learning etc) to a user of the system 1.

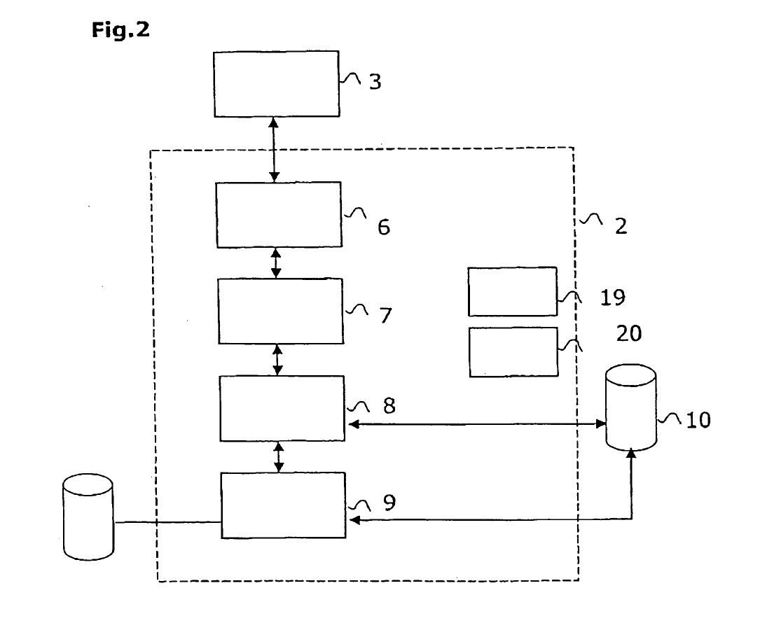

Now is referred to FIG. 2 illustrating a preferred embodiment of the apparatus 2 for controlling the learning system. Typically the apparatus 2 is provided as a software-only solution illustrated by the dashed border of the apparatus 2. The apparatus 2, in this figure illustrated by a simplified block diagram showing the functional means, comprises means 6 for identification and/or verfication of a user (illustrated as an user terminal 4) of a particular service. This means 6 is connected by a double-headed arrow to the user terminal 4, which illustrates a flow of input and output data. The features of this means 6 will not be described in more detail in the following, since they are well-known for a person skilled in the art. The apparatus 2 also comprises administration means 7 providing a user to some control of the system 1, for instance to select which service etc is demanded. The apparatus 2 further comprises means 8 for registration. This means 8 for registration registers transactions a user performs and stores data in a system data base 10 comprising user specific information such as user-profiles etc. Other examples of such data is statistical data, and data about subjects. This data is then extracted for example for training the user. This will be further described below in more detail.

Alternatively, the means 6 for identification, the administration means 7 and the registration means 8 can be combined in the same means or can be provided in or linked directly to the system data base 10. Also the route the means 6, 7 and 8 communicate can follow any suitable route, for instance in a consecutive order, whereby the registration means 8 and/or possibly a calculating means 9 is/are connected to the content and system databases 5, 10.

Moreover, it is not necessary that the system data base 10 is permanently connected to the apparatus 2, since it can also be located outside the apparatus 2 and connectable to the same when required. Alternatively, more than one system data base can also be provided, for instance a cluster of servers.

Below, the invention will be described in more detail by describing different features, starting with a description of a learning tool.

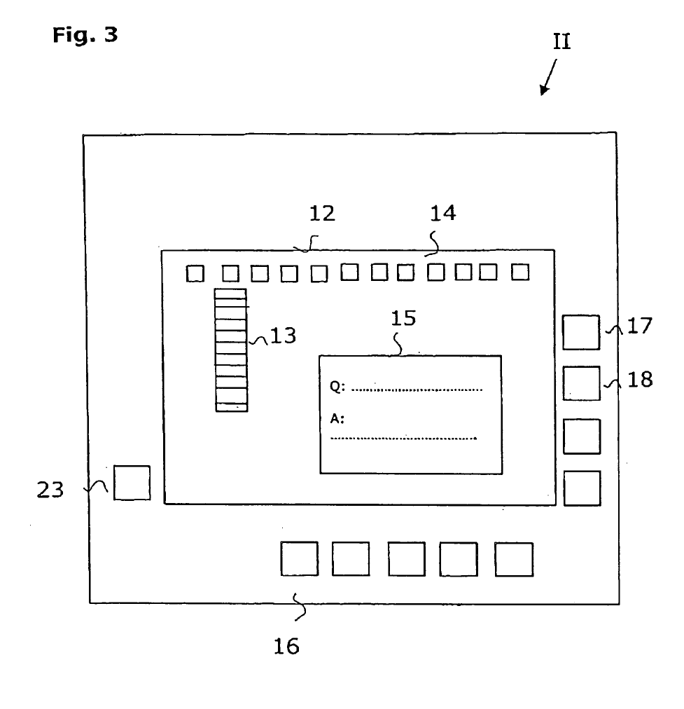

Now is referred to FIG. 3 illustrating a block diagram of a learning tool 11, typically implemented as software, which can be downloaded into a user's computer. Typically the learning tool 11 is connected (via a communication network such as the Internet) to the system data base comprising information units, typically at least two information units such as pairs of question/answers (Q/A:s), and if suitable to the content data base, but also stand-alone programs such as Java-applets or plug-ins that can communicate with a data base when required could be used. Herein, a “Java applet” is a program that runs within a Java-enabled web-browser, which is a computer application program that displays documents received over the Internet. Herein, a “plug-in” is a program that becomes part of the browser.

Preferably, the learning tool 11 operates as a client in a web-based client-server architecture, wherein a cluster of servers operates against several (typically a large number of) user profiles, (another way of describing it better could be to regard the user profiles as “accounts”), on-line or off-line. This could be implemented as user profiles stored in the content database and the cluster connectable to the same, preferably via the calculating means described above. In off-line mode, each user profile, typically stored in the system data base, has one or more down-loadable off-line clients for computers, such as PC, PDA or mobile phones, which then can be linked to the central cluster of servers at suitable time points. Furthermore, the learning tool 11 comprises an interface 12 for presenting data to, and receiving data from, a user of the computer. Typically, this interface 12 is a graphical interface. In this figure, the interface 12 is a screen display, as it appears on a users s computer. Herein, the interface 12 is in the form of a web page having drop-down list boxes 13 and tool bars 14 operating in a conventional way. Typically, the learning tool 11 provides both testing and learning functions to a user thereof.

In the learning tool 11 there are a number of information units stored. An information unit typically comprises a Q/A. In a “training” mode (for instance offline), the interface 12 shows an information unit, for instance a question, or a Q/A simultaneously, which the user should evaluate. This question can be presented as text for instance in a textbox 15, but also other media such as sound or video could be employed as a question. (It is also possible to invert the Q/A to an answer/question (A/Q) instead, but this will not be further described, since it is similar to a Q/A). The user evaluates the question and thinks of an appropriate answer, typically without entering any data. For instance voice controlled evaluation or the like could be employed. Thereafter, (or simultaneously), the learning tool 11 presents an answer. It could also be possible that the learning tool 11 determines whether it was a correct answer or not and presents the result in a way selected by the user, for instance as text in the text box 15, but this would typically require more processing power. Wrong answers (typically evaluated by the user) and other data is then stored for each Q/A, typically in a memory 23 of the learning tool 11 (This storage is not further-described, since it is well known for a person skilled in the art. In the end, for instance after a sufficient time, or the like, the stored data is further transferred to the system data base of the apparatus for controlling the learning system, in a conventional way when the learning tool 11 is communicating with the apparatus for controlling the learning system. Of course, data can directly be stored in the system data base in the case of an on-line connection to the same. However, this situation will not be further described. It could also be possible for a user to select, say 10% of the “most difficult questions” to be trained The invention provides for a user to select almost any desired mode to achieve efficient training.

Typically a simple question/answer format is provided; however, more fields, or multiple right answers could also be implemented. However, typically, changing format does not change the principle of checking answers by the user. It could also be possible to provide the questions with hints, according to different levels that could be set by a user.

The learning tool could also be provided with means for statistical information and rpeans for handling a large number of different Q/A files, so that a user easily can have an overview and select a proper one. Typically, according to the invention, this statistical information could be presented for each Q/A at any time. Also additional more conventional functions such as number of remaining Q/A:s, file name information etc could be provided

According to a preferred embodiment of the invention, the learning tool 11 also comprises a sorting tool 17 for optimised repetition of Q/A:s. This sorting tool 17 sorts a Q/A that has been correctly answered, so that it is presented again after a large number of other Q/A:s have been posed, alternatively after a considerably longer time period than incorrectly answered questions. For an incorrectly answered Q/A the sorting tool 17 sorts the Q/A so that it is presented again after a lesser number of other Q/A:s have been posed, alternateively after a considerably shorter time period than correctly answered questions. Alternatively or in combination, random generation (typically provided by means of a random generator) could be used as a variable presenting the order which the learning tool 11 presents new Q/A:s to the user. After the user has answered a question correctly a sufficient number of times, specified by an administrator of the system (typically set be the administration means 7 in the apparatus 2 in FIG. 2), this Q/A is transferred to the system data base 10 and is marked as learned for the user at a certain time point In this way questions that are learned-or questions that have been repeated so many times that they can be estimated to be known can be separated. This sorting tool 17 could also be provided outside the learning tool 11, for instance depending on how powerful the processor implementing the learning tool is.

According to another preferred embodiment of the invention, there is provided a filter tool 18 for presenting question/answers in a particular order. For instance, cognitive and linguistical filters of the filter tool 18 analyse the content in each Q/A to be able to sort the questions or the answers of two or more consecutive questions are similar (if similar pronounced, spelled or if they have similar content). Further filters could also be implemented in this filter tool.

The learning tool 11 (or the system 1) may also be provided with a feature providing subsets of questions, so that it is possible to train a particular area of interest, to better achieve a goal for a user. The learning tool 11 (or the system 1) may also comprise a tool for learning according to a target level and a tool for measuring learning speed, rate of learning. In a user profile (typically provided in the system data base) there can be a measuring profile linked to a specific user and/or subject of interest. The measuring profile stores how many Q/A:s that are learned for a particular time period. The measured speed forms a basis for estimating learning result to a user. This gives the user opportunity to quantify a relative or absolute target as regards learning. It is also possible to provide a planning tool. By means of this, it is for instance possible to estimate a point in time when a user will reach a target level after stating the amount of available time to train, say two hours each week, or according to any other plan.

The learning tool 11 may also be connectable to a tool 19 for optimised repetition. This tool 19 can also be implemented in the learning tool 11, but in this case typically provided with a limited functionality, whereby data is stored in the learning tool for further transfer to the apparatus at a later stage. A point of time when a Q/A is marked as learned for a particular user is stored within this tool 19. The time T_{next test} to which the user has to answer this question again, i. e. to be able to control his knowledge is controlled by this tool. If the answer is wrong, this question is not denoted as learned any more and is transferred to the questions that have to be learned. If, on the contrary, the Q/A is correctly answered, the time period until when this question must be answered again, is extended by a factor, say a factor two. When this time period T_{next test} is longer than a predetermined time period, this Q/A is marked as knowledge, which is not further checked, but still kept in the system.

The tool 19 may also select a number of Q/A estimated as knowledge in the diagnosis tool 20 to be included for repetition. Correctly answered these are marked as knowledge and not further checked, but still kept in the system. If incorrectly answered these are transferred to the questions to be learned.

In the system data base 10, a number of subjects comprising Q/A:s are stored together with statistical information. This system data base 10 can also store information about user profiles, i.e. individual information such as statistical information, questions marked as known, either marked as learned, estimated as knowledge or marked as knowledge.

Each subject has a general structure accessible for each user profile. The learning tool 11 receives information for each subject to be used for Q/A:s intended for learning. Each Q/A has its own hierarchical number, which the administrator decides based on parameters such as how frequent a question is, how useful and how relevant data is to decide bow Q/A:s should be presented to a user. The numbers are different for different users, but also a general structure may exist A typical example of the general structure is for instance: In subject Swedish/English the question/answer “G\dot{a}/walk” will have a lower number than question/answer “Bank charter/bankoktroj”. A typical example of a user related structure is separation into dynamic subsets for different users. For instance, for a user category of shippers, words concerning maritime terms are of greater importance than for a group of conventional users. Similarly, for Swedish users learning English, for instance the term “midsommarst\dot{a}ng (maypole) is of greater importance than for German users learning English. Hence the difference in hierarchical structure in the content data base.

According to yet a preferred embodiment of the invention, a diagnosis tool 20 could also be implemented for the learning tool 11, to be able to estimate the knowledge of a user within a subject before the user for a first time starts to use the learning tool 11 in a particular subject. The user then runs the testing means for a number of question/answers being selected at different hierarchical levels. The diagnosis tool then estimates all Q/A with a lower number as being already known and is marked as estimated knowledge. Also the tool could analyse digital texts created by the user to estimate the knowledge.

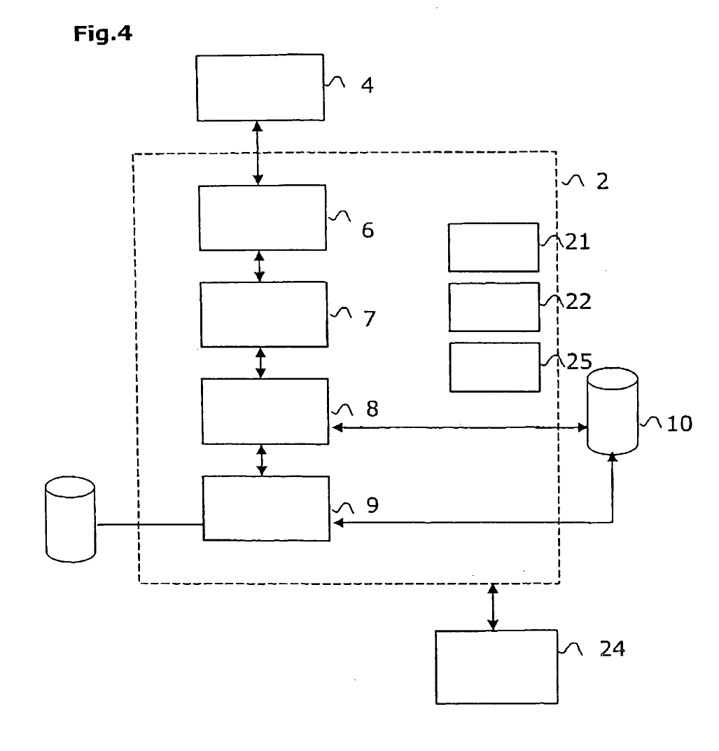

Now is referred to FIG. 4 illustrating a preferred embodiment of the invention. The apparatus 2 can also a comprise tool 21 for extracting questions from a digital text such as a document on the Internet. The tool 21 for extracting questions checks these questions with already existing questions of the system data base 10 and extracts a number of questions (without a corresponding answer). Then answers may either automatically be generated by the system or manually created by the user or administrator.

In the system 1, there could further be provided, according to yet another preferred embodiment of the invention, an intelligent proactive dictionary 22. If, for instance the subject is a language for instance Swedish/Swedish, or two different languages such as Swedish/French an intelligent dictionary (operating in both directions) could be provided in the system. A digital text, for instance a page on the Internet, or typically a large number of pages, could be checked (matched against the Q/A marked as learned, estimated as knowledge or knowledge) to a user's profile to look up words that are not known by the user to be able to present Q/A:s simultaneously as while the user is reading the text. These words could then be presented at the same speed (or any other suitable speed) as the user reads the text.

It is possible for the user to decide whether or not the dictionary 22, based on level of skill, occurrence, benefit and relevance should select words and transfer them to the learning tool 11. The user may also deselect already selected words, and add selected words.

According to yet another preferred embodiment of the invention, there can also provided a tool 25 for extracting teaching or learning material, for instance in the form of text, from digital text (e.g. the Internet) depending on stated subject of interest of the user or the user's teacher, and/or other parameters such as text containing already learned Q/A:s. The tool then determines based on these parameters, which text should be selected, whereby the text can be handled by the dictionary 22 as described above. It is possible for the user to set how many new (unknown) words can be tolerated, say five percent (5%) or any other absolute number or share of new (unknown) words, depending on tolerance level of the user.

It could also be possible to provide an external dictionary 24, if required, to work with the dictionary 22 and/or the tool 25 for extracting teaching or learning material. This dictionary 24 could be any available single or multiple language conventional dictionary, such as Webster's.

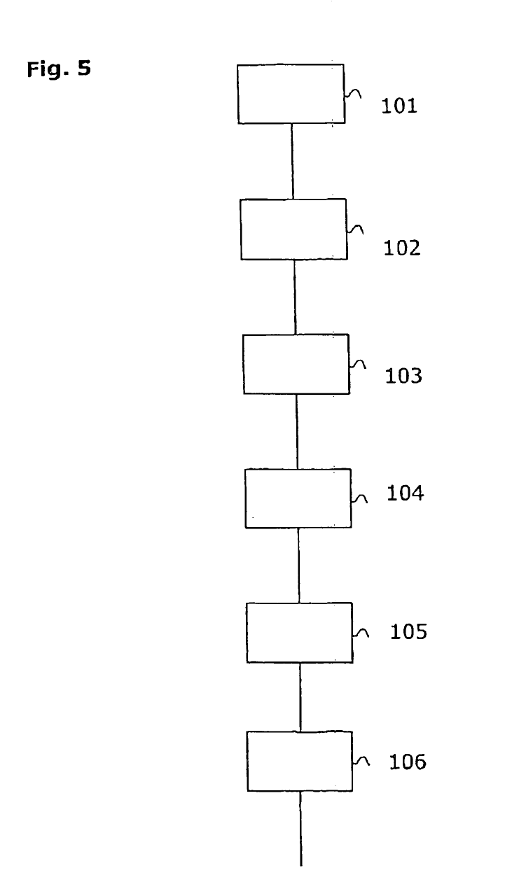

In FIG. 5 is illustrated a flow-chart of the method according to a preferred embodiment of the invention. In a first step 10 at least one question is shown for a user, in a second step 102 and answer is received from the user in a third step 103 a corresponding answer to said at least one question is presented to the user, in a fourth step 104 the user is urged to self-assess his answer for correctness to said at least one question, or alternatively to the fourth step 104, in a fifth step 105 the answer is determined by the system as correct or not, and in a sixth step 106 the user's knowledge is esturrated and/or predicted. Self-assessment provides a simpler interface compared to other techniques, whereby the system controls answers. According to another embodiment of the invention, there is provided a computer program product for a computer. The computer can for instance be a server connected or part of the communication network, or a cluster of servers distributed in the network.

1.-24. (canceled)

25. System for individual learning, said system (1) comprising:
an apparatus (2) for controlling the learning system (1),
at least one communication network (3),
at least one user terminal (4),
at least one content data base (5) provided with information units, preferably questions and answers (Q/A),
said content data base (5) being connectable to said apparatus (2), wherein said apparatus (2) further comprises at least one system data base (10) for storing user specific data, means for identification and/or verification of a user, administration means providing said user to control the system (1), and means (8) for registration of transactions a user performs, wherein said apparatus (2) is connectable to a learning tool (11) comprising an interface (12) for presenting data to the user, wherein the learning tool (11) is arranged to provide selective training according to the user's knowledge and to present a dynamic image of the knowledge status for the user in each point in time.

26. System according to claim 1, wherein said system data base (10) is adapted to store information about user profiles, i. e. individual information such as statistical information, one such information being current type of learning state, or knowledge status, for each Q/A in relation to respective user, said learning states comprising the types: “not learned”, “test required”, “repetition required”, “estimated as knowledge”, “knowledge”, and “knowledge not further checked”, that said learning tool 11 is connectable to, or comprises, a test and repetition tool (19) for optimised long term repetition, that said test and repetition tool 19 is adapted to store a point of time when a Q/A is marked as “knowledge” for a particular user, that said test and repetition tool (19) is adapted to control the time T_{next test} to which the user has to answer this question again, that if no repetition or test is made to prolong the time T_{next test}, then said test and repetition tool (19) is adapted to expire the point in time T_{next test} and change the state of the Q/A from “knowledge” to “test required”, that if no test is done by the user then said test and repetition tool (19) is adapted to deteriorate the virtual dynamic image of said user's acquired knowledge in the system over time until all Q/A marked as “knowledge” changes state to “test required”, that said test and repetition tool (19) is adapted to pose the Q/A question to the user at a point in time when test of a Q/A is performed by the user through the test and repetition tool (19), that if the answer to a question is wrong, then said test and repetition tool (19) is adapted to change the status of this Q/A to “repetition required”, that if the Q/A is correctly answered, then the test and repetition tool (19) is adapted to change the status of the Q/A to “knowledge” and extend the time period T_{next test} by a factor higher than one, say a factor two (2), that if time has passed between the T_{next test} expired and the user started the test for the Q/A, then said test and repetition tool (19) is adapted to add this time to the T_{next test} before the extension factor is applied, and that when the time period T_{next test} is longer than a predetermined time period, then said test and repetition tool (19) is adapted to mark this Q/A as “knowledge not further checked”.

27. System according to claim 2, wherein said test and repetition tool (19) comprises a sorting tool (17), that said sorting tool (17) is adapted to perform repetition using a short term learning cycle when a Q/A has the state “repetition required”, and that when repetition has been duly performed using said short term learning cycle, then said test and repetition tool (19) is adapted to extend the time period T_{next test} by a factor lower than one, say a factor zero point eight (0.8).

28. System according to claim 1, wherein filter means (18) are provided, preferably in the learning tool (11), for presenting information units, such as Q/A:s in a particular order to the user.

29. System according to claim 1, wherein diagnosis means (20) is provided to estimate the knowledge of the user within a subject.

30. System according to claim 1, wherein tool (21) for extracting information units from non-preprepared information, preferably to create Q/A:s from a non-preprepared digital text is provided in the apparatus (2).

31. System according to claim 1, wherein at least one proactive dictionary (22) is connectable to the system (1) or provided in the apparatus (2), said dictionary (22) being adapted to present words considered by the system (1) to be unknown for the user.

32. System according to claim 7, wherein said dictionary (22) is arranged to check a text, either stored in the system or introduced to the system from an external source (e.g. Internet), to a user's profile, to look up data not known by the user, and presenting translations or other types of Q/A:s simultaneously.

33. System according to claim 8, wherein said dictionary (22) is connectable to a tool for extraction of teaching or learning material from texts and preferably checked to a user's profile for acceptable texts or fragments of texts, based on stated interest and level of knowledge.

34. System according to claim 8, wherein at least one external dictionary (24) is connectable to the system (1), said at least one external dictionary being adapted to cooperate with the system.

35. System according to claim 1, wherein the administration means (7) is arranged to provide a user to control the system (1).

36. System according to claim 1, wherein the means (8) for registration is arranged to register transactions a user performs, and to store data in the system data base (10) comprising user specific data.

37. System according to claim 1, wherein the user terminal (4) is a mobile phone, a PDA, a laptop or a PC.

38. System for individual learning, said system (1) comprising:
an apparatus (2) for controlling the learning system (1),
at least one communication network (3),
at least one user terminal (4),
at least one content data base (5) provided with information units, preferably questions and answers (Q/A),
said content data base (5) being connectable to said apparatus (2), wherein said apparatus (2) further comprises at least one system data base (10) for storing user specific data, means for identification and/or verification of a user, administration means providing said user to control the system (1), and means (8) for registration of transactions a user performs, wherein at least one proactive dictionary (22) is connectable to the system (1) or provided in the apparatus (2), said dictionary (22) being adapted to present words considered by the system (1) to be unknown for the user.

39. System according to claim 14, wherein said dictionary (22) is arranged to check a text, either stored in the system or introduced to the system from an external source (e.g. Internet), to a user's profile, to look up data not known by the user, and presenting translations or other types of Q/A:s simultaneously.

40. System according to claim 15, wherein said dictionary (22) is connectable to a tool for extraction of teaching or learning material from texts and preferably checked to a user's profile for acceptable texts or fragments of texts, based on stated interest and level of knowledge.

41. System according to claim 15, wherein at least one external dictionary (24) is connectable to the system (1), said at least one external dictionary being adapted to cooperate with the system.

42. System according to claim 14, wherein tool (21) for extracting information units from non-preprepared information, preferably to create Q/A:s from a non-preprepared digital text is provided in the apparatus (2).

43. System according to claim 14, wherein said apparatus (2) is connectable to a learning tool (11 ) comprising an interface (12) for presenting data to the user, said the learning tool (11) being arranged to provide selective training according to the user's knowledge and to present a dynamic image of the knowledge status for the user in each point in time.

44. System according to claim 19, wherein said system data base (10) is adapted to store information about user profiles, i. e. individual information such as statistical information, one such information being current type of learning state, or knowledge status, for each Q/A in relation to respective user, said learning states comprising the types: “not learned”, “test required”, “repetition required”, “estimated as knowledge”, “knowledge”, and “knowledge not further checked”, that said learning tool 11 is connectable to, or comprises, a test and repetition tool (19) for optimised long term repetition, that said test and repetition tool 19 is adapted to store a point of time when a Q/A is marked as “knowledge” for a particular user, that said test and repetition tool (19) is adapted to control the time T_{next test} to which the user has to answer this question again, that if no repetition or test is made to prolong the time T_{next test}, then said test and repetition tool (19) is adapted to expire the point in time T_{next test} and change the state of the Q/A from “knowledge” to “test required”, that if no test is done by the user then said test and repetition tool (19) is adapted to deteriorate the virtual dynamic image of said user's acquired knowledge in the system over time until all Q/A marked as “knowledge” changes state to “test required”, that said test and repetition tool (19) is adapted to pose the Q/A question to the user at a point in time when test of a Q/A is performed by the user through the test and repetition tool (19), that if the answer to a question is wrong, then said test and repetition tool (19) is adapted to change the status of this Q/A to “repetition required”, that if the Q/A is correctly answered, then the test and repetition tool (19) is adapted to change the status of the Q/A to “knowledge” and extend the time period T_{next test} by a factor higher than one, say a factor two (2), that if time has passed between the T_{next test} expired and the user started the test for the Q/A, then said test and repetition tool (19) is adapted to add this time to the T_{next test} before the extension factor is applied, and that when the time period T_{next test} is longer than a predetermined time period, then said test and repetition tool (19) is adapted to mark this Q/A as “knowledge not further checked”.

45. System according to claim 20, wherein said test and repetition tool (19) comprises a sorting tool (17), that said sorting tool (17) is adapted to perform repetition using a short term learning cycle when a Q/A has the state “repetition required”, and that when repetition has been duly performed using said short term learning cycle, then said test and repetition tool (19) is adapted to extend the time period T_{next test} by a factor lower than one, say a factor zero point eight (0.8).

46. System according to claim 19, wherein filter means (18) are provided, preferably in the learning tool (11), for presenting information units, such as Q/A:s in a particular order to the user.

47. System according to claim 14, wherein diagnosis means (20) is provided to estimate the knowledge of the user within a subject.

48. System according to claim 14, wherein the administration means (7) is arranged to provide a user to control the system (1).

49. System according to claim 14, wherein the means (8) for registration is arranged to register transactions a user performs, and to store data in the system data base (10) comprising user specific data.

50. System according to claim 14, wherein the user terminal (4) is a mobile phone, a PDA, a laptop or a PC.

51. A method for individual learning in a learning system (1), wherein said learning system (1) comprises:
an apparatus (2) for controlling the learning system (1),
at least one communication network (3),
at least one user terminal (4),
at least one content data base (5) provided with information units, preferably questions and answers (Q/A),
said content data base (5) being connected to said apparatus (2), wherein said apparatus (2) further comprises at least one system data base (10) for storing user specific data, means for identification and/or verification of a user, administration means providing said user to control the system (1), and means (8) for registration of transactions a user performs, wherein said apparatus (2) is connected to a learning tool (11) comprising an interface (12) for presenting data to the user, wherein the learning tool (11) provides selective training according to the user's knowledge and presents a dynamic image of the knowledge status for the user in each point in time.

52. A method according to claim 27, wherein said system data base (10) stores information about user profiles, i. e. individual information such as statistical information, one such information being current type of learning state, or knowledge status, for each Q/A in relation to respective user, said learning states comprising the types: “not learned”, “test required”, “repetition required”, “estimated as knowledge”, “knowledge”, and “knowledge not further checked”, that said learning tool 11 is connected to, or comprises, a test and repetition tool (19) for optimised long term repetition, that a point of time when a Q/A is marked as “knowledge” for a particular user is stored within said test and repetition tool 19, that the time T_{next test} to which the user has to answer this question again is controlled by said test and repetition tool (19), that if no repetition or test is made to prolong the time T_{next test}, then the point in time T_{next test} expires and the state of the Q/A is changed from “knowledge” to “test required”, that if no test is done by the user the virtual dynamic image of the user's acquired knowledge in the system deteriorates over time until all Q/A marked as “knowledge” changes state to “test required”, that at a point in time when test of a Q/A is performed by the user through the test and repetition tool (19) the Q/A question is posed to the user, that if the answer to a question is wrong, then this Q/A changes state to “repetition required”, that if the Q/A is correctly answered, then the state of the Q/A changes to “knowledge” and the time period T_{next test} is extended by a factor higher than one, say a factor two (2), that if time has passed between the T_{next test} expired and the user started the test for the Q/A, this time is added to the T_{next test} before the extension factor is applied, and that when the time period T_{next test} is longer than a predetermined time period, this Q/A is marked as “knowledge not further checked”.

53. A method according to claim 28, wherein when a Q/A has the state “repetition required” then repetition is performed using a short term learning cycle, and that when repetition has been duly performed using said short term learning cycle, the time period T_{next test} is extended by a factor lower than one, say a factor zero point eight (0.8).

54. A method according to claim 27, wherein filter means (18) presents information units, such as Q/A:s in an order optimised for the specific user's needs.

55. A method according to claim 27, wherein diagnosis means (20) estimates the knowledge of the user within a subject.

56. A method according to claim 27, wherein tool (21) for extracting information units from non-preprepared information creates Q/A:s from a non-preprepared digital text.

57. A method according to claim 27, wherein at least one proactive dictionary (22) is connected to the system (1) or provided in the apparatus (2), said dictionary (22) presenting words considered by the system (1) to be unknown for the user.

58. A method according to claim 33, wherein said dictionary (22) checks a text, either stored in the system or introduced to the system from an external source (e.g. Internet), to a user's profile, to look up data not known by the user, and presents translations or other types of Q/A:s simultaneously.

59. A method according to claim 34, wherein said dictionary (22) is connected to a tool (25) for extraction of teaching or learning material from texts and preferably checked to a user's profile for acceptable texts or fragments of texts, based on stated interest and level of knowledge.

60. A method according to claim 34, wherein at least one external dictionary (24) is connected to the system (1), and that said at least one external dictionary cooperates with the system.

61. A method according to claim 27, wherein the administration means (7) provides a user to control the system (1).

62. A method for individual learning in a learning system (1), wherein said learning system (1) comprises:
an apparatus (2) for controlling the learning system (1),
at least one communication network (3),
at least one user terminal (4),
at least one content data base (5) provided with information units, preferably questions and answers (Q/A),
said content data base (5) being connected to said apparatus (2), wherein said apparatus (2) further comprises at least one system data base (10) for storing user specific data, means for identification and/or verification of a user, administration means providing said user to control the system (1), and means (8) for registration of transactions a user performs, wherein said apparatus (2) is connected to at least one proactive dictionary (22), said dictionary (22) presenting words considered by the system (1) to be unknown for the user.

63. A method according to claim 38, wherein said dictionary (22) checks a text, either stored in the system or introduced to the system from an external source (e.g. Internet), to a user's profile, to look up data not known by the user, and presents translations or other types of Q/A:s simultaneously.

64. A method according to claim 39, wherein said dictionary (22) is connected to a tool (25) for extraction of teaching or learning material from texts and preferably checked to a user's profile for acceptable texts or fragments of texts, based on stated interest and level of knowledge.

65. A method according to claim 39, wherein at least one external dictionary (24) is connected to the system (1), and that said at least one external dictionary cooperates with the system.

66. A method according to claim 38, wherein tool (21) for extracting information units from non-preprepared information creates Q/A:s from a non-preprepared digital text.

67. A method according to claim 38, wherein a learning tool (11) comprising an interface (12) for presenting data to the user provides selective training according to the user's knowledge and presents a dynamic image of the knowledge status for the user in each point in time.

68. A method according to claim 43, wherein said system data base (10) stores information about user profiles, i. e. individual information such as statistical information, one such information being current type of learning state, or knowledge status, for each Q/A in relation to respective user, said learning states comprising the types: “not learned”, “test required”, “repetition required”, “estimated as knowledge”, “knowledge”, and “knowledge not further checked”, that said learning tool 11 is connected to, or comprises, a test and repetition tool (19) for optimised long term repetition, that a point of time when a Q/A is marked as “knowledge” for a particular user is stored within said test and repetition tool 19, that the time T_{next test} to which the user has to answer this question again is controlled by said test and repetition tool (19), that if no repetition or test is made to prolong the time T_{next test}, then the point in time T_{next test} expires and the state of the Q/A is changed from “knowledge” to “test required”, that if no test is done by the user the virtual dynamic image of the user's acquired knowledge in the system deteriorates over time until all Q/A marked as “knowledge” changes state to “test required”, that at a point in time when test of a Q/A is performed by the user through the test and repetition tool (19) the Q/A question is posed to the user, that if the answer to a question is wrong, then this Q/A changes state to “repetition required”, that if the Q/A is correctly answered, then the state of the Q/A changes to “knowledge” and the time period T_{next test} is extended by a factor higher than one, say a factor two (2), that if time has passed between the T_{next test} expired and the user started the test for the Q/A, this time is added to the T_{next test} before the extension factor is applied, and that when the time period T_{next test} is longer than a predetermined time period, this Q/A is marked as “knowledge not further checked”.

69. A method according to claim 44, wherein when a Q/A has the state “repetition required” then repetition is performed using a short term learning cycle, and that when repetition has been duly performed using said short term learning cycle, the time period T_{next test} is extended by a factor lower than one, say a factor zero point eight (0.8).

70. A method according to claim 38, wherein filter means (18) presents information units, such as Q/A:s in an order optimised for the specific user's needs.

71. A method according to claim 38, wherein diagnosis means (20) estimates the knowledge of the user within a subject.

72. A method according to claim 38, wherein the administration means (7) provides a user to control the system (1).

73. A Computer program product stored on a computer useable medium, comprising in a computer readable code means to make the computer execute the method according claim 27.
